(19) United States
(12) Patent Application Publication
(10) Pub. No.: US 2025/0141247 A1
(43) Pub. Date: May 1, 2025

(54) Optical Data Transmission Using a Power Tool Device

(71) Applicant: Milwaukee Electric Tool Corporation, Brookfield, WI (US)

(72) Inventors: Jonathan E. Abbott, Milwaukee, WI (US); Anthony M. Davis, Brookfield, WI (US)

(21) Appl. No.: 18/691,310

(22) PCT Filed: Sep. 27, 2022
(86) PCT No.: PCT/US2022/044913

§ 371 Date: Mar. 12, 2024

Related U.S. Application Data
(60) Provisional application No. 63/248,809, filed on Sep. 27, 2021.

(51) Int. Cl. H02J 7/00; H04B 10/116

(52) U.S. Cl. CPC H02J 7/0047; H02J 7/00032; H04B 10/116

(57) ABSTRACT

Data are optically transmitted from a power tool device, such as a power tool, a power tool battery charger, power tool pack adapter, and/or a battery pack. The data are stored in a memory of the power tool device and are encoded as optical signal data to provide an encoded representation of the stored data. An optical transmitter (e.g., a light emitting diode or a flat panel display) transmits the optical signal data, which are detected or otherwise received by an optical receiver device, which may include a camera or other photodetector. The optical signal data may include light signals generated by an LED, where the data are encoded using an encoding scheme that modulates one or more characteristics (e.g., amplitude, wavelength, color) of the generated light signals. The optical signal data may also include images (e.g., barcodes, QR codes) or characters.

### CROSS-REFERENCE TO RELATED APPLICATIONS

The present application is based on and claims priority from U.S. Patent Application No. 63/248,809, filed on Sep. 27, 2021, the entire disclosure of which is incorporated herein by reference.

### BACKGROUND

Power tools are typically powered by portable battery packs. These battery packs range in battery chemistry and nominal voltage and can be used to power numerous power tools and electrical devices. A power tool battery charger includes one or more battery charger circuits that are connectable to a power source and operable to charge one or more power tool battery packs connected to the power tool battery charger.

### SUMMARY OF THE DISCLOSURE

The present disclosure provides a method for optically transmitting data from a power tool device. Data stored in a memory of the power tool device are transmitted as optical signal data by modulating light generated by a light emitting diode of the power tool device, wherein the light emitting diode has a primary function that is different from optical data transmission. The optical signal data are received by an optical receiver device by detecting the light generated by the optical transmitter of the power tool device. The received optical signal data are stored in a memory of the optical receiver device.

Implementations may include one or more of the following features.

The power tool device may include a power tool battery charger. As an example, the primary function of the light emitting diode may include indicating a charging status for the power tool battery charger.

The power tool device may include a battery pack. As an example, the primary function of the light emitting diode may include indicating a state-of-charge of the battery pack.

The power tool device may include a power tool. As an example, the primary function of the light emitting diode may include indicating a mode of operation of the power tool.

The power tool device may include a work light. As an example, the primary function of the light emitting diode may include illuminating a space.

Transmitting the data stored in the memory of the power tool device as optical signal data may include: accessing the data from the memory of the power tool device; encoding the data using an electronic processor of the power tool device, generating encoded data that include control parameters for modulating the light generated by the light emitting diode; and transmitting the optical signal data using the electronic processor to modulate the light generated by the light emitting diode based on the control parameters in the encoded data. Encoding the data using the electronic processor may include encoding the data using a binary encoding.

The control parameters may indicate an analog modulation of the light generated by the light emitting diode. As another example, the control parameters may indicate a digital modulation of the light generated by the light emitting diode. As still another example, the control parameters may indicate modulating an amplitude of the light generated by the light emitting diode. As yet another example, the control parameters may indicate modulating a color of the light generated by the light emitting diode.

The optical receiver device may include a camera. As one example, the camera can be coupled to a mobile device. As another example, the camera is a standalone security camera.

The optical receiver device may include a photodetector. The photodetector may be coupled to a second power tool device.

In other aspects, the present disclosure provides a power tool device that includes a housing, an optical transmitter coupled to the housing, a memory, and an electronic processor coupled to the optical transmitter and the memory. The optical transmitter is configured to transmit optical signal data as light signals in a visible spectrum. The memory is configured to store power tool device data. The electronic processor is configured to retrieve the data from the memory; encode the data as optical signal data for transmission by the optical transmitter; and control the optical transmitter to transmit the optical signal data.

Implementations may include one or more of the following features.

The power tool device where the optical transmitter may include a light emitting diode and the electronic processor is configured to: encode the data as the optical signal data by determining control parameters for modulating light generated by the light emitting diode; and control the light emitting diode to transmit the optical signal data by modulating light generated by the light emitting diode based on the control parameters.

The power tool device may include a power tool.

The power tool device may include a battery pack.

The power tool device may include a power tool battery charger.

In still other aspects, the present disclosure provides a power tool device that includes a housing, a flat panel display coupled to the housing, a memory, and an electronic processor coupled to the flat panel display and the memory. The flat panel display is configured to transmit optical signal data. The memory is configured to store power tool device data. The electronic processor is configured to retrieve the data from the memory; encode the data as optical signal data indicating an encoded representation of the data retrieved from the memory; and control the flat panel display to generate the optical signal data as a display element on the flat panel display.

Implementations may include one or more of the following features.

The power tool device where the flat panel display may include a liquid crystal display. The flat panel display may include a light emitting diode display. The flat panel display may include an electrophoretic display. The electronic processor may be configured to generate the display element as an image. The electronic processor may be configured to encode the data as optical signal data indicating the encoded representation of the data as a quick response (QR) code.

### BRIEF DESCRIPTION OF THE DRAWINGS

The accompanying drawings, which are incorporated in and form a part of this specification, illustrate embodiments of the disclosure and, together with the description, serve to explain principles of the embodiments.

FIG. 1 illustrates an example power tool optical communication system.

FIG. 2 is a block diagram of an example power tool device that can be implemented in the power tool optical communication system of FIG. 1.

FIG. 3 is a block diagram of an example optical receiver device that can be implemented in the power tool optical communication system of FIG. 1.

FIG. 4 is a flowchart illustrating a method for optically transmitting data from a power tool device using an optical transmitter (e.g., LED or other light, flat panel display) of the power tool device.

FIG. 5 is a flowchart illustrating a method of receiving optical signal data with an optical receiver device, where the optical signal data were transmitted by a power tool device.

### DETAILED DESCRIPTION

Many power tool devices (e.g., power tools, power tool battery chargers, battery packs, power tool adapters, power suppled (e.g., inverters), lasers (e.g., rotary lasers, point lasers)) are not directly or fully internet-of-things (“IoT”) compatible. For example, the power tool devices may lack a Bluetooth®, Zigbee®, Wi-Fi®, cellular, NFC, or other wireless transmission means. Some power tool devices may have a wired interface, such as a universal serial bus (“USB”) port or dual-function battery interface terminals, that enable data communication, but these require special coupling means (e.g., adapters or USB plugs) to be able to allow such data communication.

Described here are various systems and methods in which power tool devices with one or more light outputs (e.g., work lights, LEDs for mode or settings, or displays/screens) have these visual elements operated in a manner to provide optical data transmission using free-space optical communication to an optical receiver device, such as a camera on a cell phone or a standalone camera. Free-space optical (“FSO”) communication includes optical communication techniques in which light is transmitted in free space (e.g., air, a vacuum, or the like) to wirelessly transmit data. Cell phones, also referred to as mobile phones or smartphones, are an advantageous device for receiving optical data transmission from a power tool device via free-space optical communication because they usually have a camera that could take in images and/or video. Cell phones also often have a way to communicate to other systems wirelessly via cellular, Bluetooth®, Zigbee®, Wi-Fi®, NFC, and other means. Cell phones also can run software applications (or “apps”) that can allow processing of the received optical signal data.

In some embodiments, non-optical communication means, such as acoustic communication, can also be implemented. For example, a power tool may be operable to vibrate its motor by changing from forwards to reverse. These controlled vibrations could be modulated to encode data, which could be detected by an acoustic receiving device, such as a microphone (e.g., a microphone on a cell phone).

Data that can be transmitted using these free-space optical communication techniques include power tool device data that may include usage data, maintenance data, feedback data, power source data, sensor data, environmental data, operator data, location data, rental data, among other data, which may be associated with a power tool device, such as a power tool battery charger, a battery pack, and/or a power tool.

Usage data may include usage data for a power tool battery charger, a power tool battery pack, a power tool, or other devices connected to a power tool device network, such as wireless communication devices, control hubs, access points, and/or peripheral devices (e.g., smartphones, tablet computers, laptop computers, portable music players, and the like).

Usage data for a power tool battery charger may include operation time of the power tool battery charger (e.g., how long the power tool battery charger is used in each session, the amount of time between sessions of power tool battery charger usage, and the like), times of day when battery packs are being put on and/or taken off of the power tool battery charger, unique identifiers of battery packs being put on and/or taken off of the power tool battery charger, specific hours when work is being performed on a jobsite (or being performed more or less frequently on the jobsite), days of the week when work is being performed on a jobsite (or being performed more or less frequently on the jobsite), charging patterns, a retake time (e.g., a time associated with how quickly a battery pack is taken off of a power tool battery charger), working hours associated with the power tool battery charger, and the like. In some embodiments, usage data may include data indicating the order in which batteries are put on a power tool battery charger with multiple charging ports, or on power tool battery chargers in a network of connected (e.g., wired or wirelessly) power tool battery chargers.

Usage data for a battery pack may include operation time of the battery pack (e.g., how long the battery pack is used in each session, the amount of time between sessions of battery pack usage, and the like), the types of power tool(s) on which the battery pack is being used, the frequency with which the battery pack is being used, the frequency with which the battery pack is being used with a particular power tool or power tool type, the frequency with which the battery pack is charged on a particular power tool battery charger or power tool battery charger type, the current charge capacity of the battery pack (e.g., the state of charge of the battery pack), the number of charge cycles the battery pack has gone through, the estimated remaining useful life of the battery pack, a retake time (e.g., a time associated with how quickly a battery pack is taken off of a power tool battery charger), working hours associated with the battery pack, and the like. In some embodiments, usage data may include data indicating the usage of a particular battery.

Usage data for a power tool may include the operation time of the power tool (e.g., how long the power tool is used in each session, the amount of time between sessions of power tool usage, and the like); whether a particular battery pack is used with the power tool and/or the frequency with which the particular battery pack is used with the power tool; whether a particular battery pack type is used with the power tool and/or the frequency with which the particular battery pack is used with the power tool; the type of power tool applications the power tool is frequently used for; information regarding changes in bits, blades, or other accessory devices for the power tool; working hours associated with the power tool; and the like.

More generally, usage data for a power tool device (e.g., a power tool, a battery pack, a power tool battery charger, a power supply, a power tool pack adapter, etc.) can include summary data on the usage of the power tool device. As an example, summary data may include application classifications, statistics (e.g., use statistics), on-time, time since last use, and so on.

Maintenance data may include maintenance data for a power tool battery charger, a power tool battery, and/or a power tool. For example, maintenance data may include a log of prior maintenance, suggestions for future maintenance, current firmware version, most-recent firmware update date, and the like.

Feedback data may include data indicating the manner in which a battery pack is put on a power tool battery charger, such as how forcefully the battery pack is put on the charger, whether a prolonged force is applied when placing the battery pack on the charger (e.g., by a user putting a battery pack on a power tool battery charger and holding down the battery pack for a duration of time), whether the battery pack is rapidly and repeatedly put on and taken off of the charger, whether the battery pack is returned to the charger shortly after being taken off the charger, and the like. Feedback data may also include sentiment analysis of a user, the frequency of adjusting a tool setting (e.g., the frequency of adjusting clutch settings), metrics of an algorithm's success, and the like.

Power source data may include data indicating a type of power source (e.g., AC power source, DC power source, battery power source), a type of electricity input of the power source (e.g., 120 V wall outlet, 220 V wall outlet, solar power, gas inverter, wireless charger, another power tool battery pack, another power tool battery charger, an internal battery, a supercapacitor, an internal energy storage device, a vehicle), a cost of the electricity input of the power source, and the like.

In some embodiments, the power source data can include data indicating electrical characteristics or properties of the electrical grid or circuit associated with the power source. For example, the power source data can include data indicating whether the electrical grid is balanced. As another example, the power source data can include data indicating whether circuit breakers on the electrical circuit local to the power source are likely to be tripped. As still another example, the power source data can include data indicating other characteristics of the power source, such as when the power source supplies power in a noncontinuous manner, as may be the case for solar power, then the power source data can indicate the noncontinuous manner in which power is supplied by the power source. In these instances, the power source data can be used to optimize the charging action of the power tool battery charger, such as by adjusting the charging rate in response to increases and decreases in the available power being supplied by the power source.

Sensor data may include sensor data collected using one or more sensors (e.g., voltage sensor, a current sensor, a temperature sensor, an inertial sensor) of the power tool battery charger, battery pack, and/or power tool. For example, the sensor data may include voltage sensor data indicating a measured voltage associated with the power tool battery charger, battery pack, and/or power tool. For example, such a measured voltage may include a voltage measured across positive and negative power terminals of a power tool battery charger, battery pack, and/or power tool. Likewise, the sensor data may include current sensor data indicating a measured current associated with the power tool battery charger, battery pack, and/or power tool. For example, such a measured current may include a charging current provided from a power tool battery charger and/or received by a battery pack (e.g., at power terminals of the power tool battery charger or battery pack). Additionally, such a measured current may include a discharge current provided from a battery pack and/or received by a power tool (e.g., at power terminals of the battery pack or power tool). Additionally or alternatively, the sensor data may include temperature sensor data that indicate an internal and/or operating temperature of the power tool battery charger, battery pack, and/or power tool. In some embodiments, the sensor data can include inertial sensor data, such as accelerometer data, gyroscope data, and/or magnetometer data. These inertial sensor data can indicate a motion of the power tool battery charger, battery pack, and/or power tool, and can be processed by an electronic controller to determine a force, angular rate, and/or orientation of the power tool battery charger, battery pack, and/or power tool. In some embodiments, sensor data can indicate if or when a battery pack and/or power tool were dropped. For example, the sensor data may include inertial sensor data that indicate motion of a battery pack and/or power tool consistent with that power tool device being dropped.

Environmental data may include data indicating a characteristic or aspect of the environment in which the power tool battery charger, battery pack, and/or power tool is located. For example, environmental data can include data associated with the weather, a temperature (e.g., external temperature) of the surrounding environment, the humidity of the surrounding environment, and the like.

Operator data may include data indicating an operator and/or owner of a power tool battery charger, a battery pack, a power tool, and the like. For example, operator data may include an operator identifier (ID), an owner ID, or both.

Location data may include data indicating a location of a power tool battery charger, a battery pack, a power tool, and the like. In some embodiments, the location data may indicate a physical location of the power tool battery charger, the battery pack, and/or power tool. For example, the physical location may be represented using geospatial coordinates, such as those determined via GNSS or the like. As another example, the physical location may be represented as a jobsite location (e.g., an address, an identification of a jobsite location) and may include a location within a jobsite (e.g., a particular floor in a skyscraper or other building under construction). In some other embodiments, the location data may indicate a location of the power tool battery charger, the battery pack, and/or power tool for inventory management and tracking. Additionally or alternatively, location data may include a unique identifier, such as a serial number, that is picked up by a reader (e.g., an optical receiver device) that then associates the reader's location (e.g., a cell phone GPS fix) with the location of the power tool device.

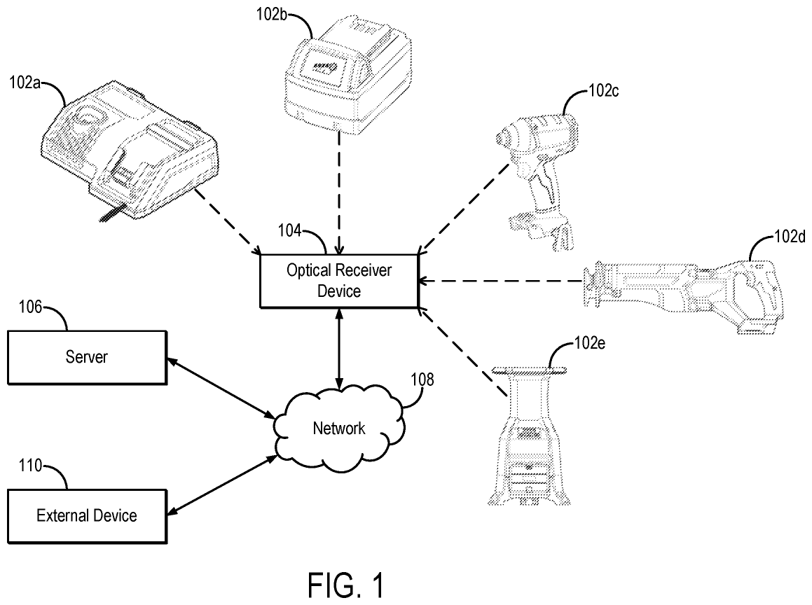

FIG. 1 illustrates a power tool optical communication system 100. The power tool optical communication system includes, among other things, a plurality of power tool devices 102a-102e, an optical receiver device 104, a server 106, a network 108, and an external device 110.

The power tool devices 102a-102e include power tools and devices used in relation to the operation of power tools. For example, the power tool devices 102a-102e can include a power tool battery charger 102a, a battery pack 102b, power tools 102c-102d, a work light 102e, as well as other devices used in conjunction with the power tool battery chargers, battery packs, and/or power tools. Each power tool 102c-102d may be the same tool or may be different tools. Accordingly, each power tool 102c-102d is configured to perform one or more specific tasks (e.g., drilling, cutting, fastening, pressing, lubricant application, sanding, heating, grinding, bending, forming, impacting, polishing, etc.). The power tool devices 102 illustrated in the power tool optical communication system 100 are representative examples. The power tool optical communication system 100 may include more or fewer power tool devices 102 and various combinations of power tool devices 102. In addition to power tools, power tool battery chargers, battery packs, and work lights, the power tool devices 102 can also include other related jobsite powered devices, such as powered coolers, lights, fans, robotics for cleaning, dust mitigation systems, safety hazard systems (e.g., alert lights, warning signs, etc.), blowers, vacuums, electronics (including computers, tablets, phones, etc., intended for the jobsite), powered hubs, gateway devices, smart mats, security cameras, charging strips, extension cords, spider boxes, radios, etc. Additionally or alternatively, the power tool device 102 can include a power tool pack adapter that can be positioned between a power tool and one or more battery packs (or other such power tool devices).

As described below in more detail, the power tool devices 102 in the power tool optical communication system 100 include an optical transmitter (e.g., one or more LEDs or other lights, a flat panel display) that is configured to transmit optical signal data, such as by modulating the output of the optical transmitter or otherwise generating an encoded representation of data with the optical transmitter. In some instances, the optical signal data may include light signals (e.g., light generated by the optical transmitter), or may include a display element (e.g., images or characters displayed on a flat panel display) that can be detected or otherwise read by the optical receiver device 104. Each power tool device 102 can collect usage data or other power tool device data, such as maintenance data, feedback data, power source data, environmental data, operator data, location data, or other data. These collected or stored data can be transmitted as optical signal data to the optical receiver, as described below in more detail. As one example, this mode of data transmission has the benefit of requiring lower power consumption than other wireless communication modes (e.g., Bluetooth®, Zigbee®, Wi-Fi®, etc.). As another example, this mode of data transmission is cost effective because it can make use of existing lights (e.g., LEDs) that are already on the power tool device 102 and which have a primary or alternative function (e.g., work light, status light, mode light). Moreover, this mode of data transmission allows for power tool devices that are otherwise not wirelessly connected (e.g., non-IoT enabled power tool devices) to share data and perform functions such as tool identification (e.g., by reading serial numbers that might get scratched off the power tool device), debugging and/or maintenance checking (e.g., in the field before sending the power tool device in to a service center), and potentially allowing location updates in a crib.

The optical receiver device 104 is in optical communication with the power tool devices 102 and is configured to receive or otherwise detect optical signal data (e.g., light signals, characters, images) generated by optical transmitters of the power tool devices 102. In general, the optical receiver device 104 include a photodetector, such as a light sensor or a camera, that is configured to receive or otherwise detect the optical signal data generated by the optical transmitter of a power tool device 102. In this way, the power tool device 102 is capable of wirelessly communicating with the optical receiver device 104 using free-space optical communication.

The network 108 may be a long-range wireless network such as the Internet, a local area network (“LAN”), a wide area network (“WAN”), or a combination thereof. In other embodiments, the network 108 may be a short-range wireless communication network, and in yet other embodiments, the network 108 may be a wired network using, for example, USB cables. In some embodiments, the network 108 may include both wired and wireless devices and connections. Similarly, the server 106 may transmit information to the external device 110 to be forwarded to the power tool devices 102 and/or optical receiver device 104.

In some embodiments, the power tool device 102 bypasses the external device 110 to access the network 108 and communicate with the server 106 via the network 108. In some embodiments, the power tool battery device 102 is equipped with a long-range transceiver instead of or in addition to the short-range transceiver. In such embodiments, the power tool device 102 communicates directly with the server 106 or with the server 106 via the network 108 (in either case, bypassing the external device 110). In some embodiments, the power tool device 102 may communicate directly with both the server 106 and the external device 110. In such embodiments, the external device 110 may, for example, generate a graphical user interface to facilitate control and programming of the power tool device 102, while the server 106 may store and analyze larger amounts of operational data for future programming or operation of the power tool device 102. In other embodiments, however, the power tool device 102 may communicate directly with the server 106 without utilizing a short-range communication protocol with the external device 110.

In the illustrated embodiment, the optical receiver device 104 communicates with the external device 110. The external device 110 may include, for example, a smartphone, a tablet computer, a cellular phone, a laptop computer, a smart watch, and the like. The optical receiver device 104 communicates with the external device 110, for example, to transmit at least a portion of the usage information or other power tool device data received from the power tool devices 102 via optical data transmission. In some embodiments, the external device 110 may include a short-range transceiver to communicate with the optical receiver device 104, and a long-range transceiver to communicate with the server 106. In the illustrated embodiment, the optical receiver device 104 can also include a transceiver to communicate with the external device 110 via, for example, a short-range communication protocol such as Bluetooth® or Zigbee®. In some embodiments, the external device 110 bridges the communication between the optical receiver device 104 and the server 106. That is, the optical receiver device 104 transmits data to the external device 110, and the external device 110 forwards the data from the optical receiver device 104 to the server 106 over the network 108.

The server 106 includes a server electronic control assembly having a server electronic processor, a server memory, and a transceiver. The transceiver allows the server 106 to communicate with the optical receiver device 104, the external device 110, or both. The server electronic processor receives usage data and/or other power tool device data from the power tool device 102 (e.g., via the optical receiver device 104), stores the received usage data and/or other power tool device data in the server memory. The server 106 may maintain a database (e.g., on the server memory) for containing power tool device data, trained machine learning controls (e.g., trained machine learning model and/or algorithms), artificial intelligence controls (e.g., rules and/or other control logic implemented in an artificial intelligence model and/or algorithm), and the like.

Although illustrated as a single device, the server 106 may be a distributed device in which the server electronic processor and server memory are distributed among two or more units that are communicatively coupled (e.g., via the network 108).

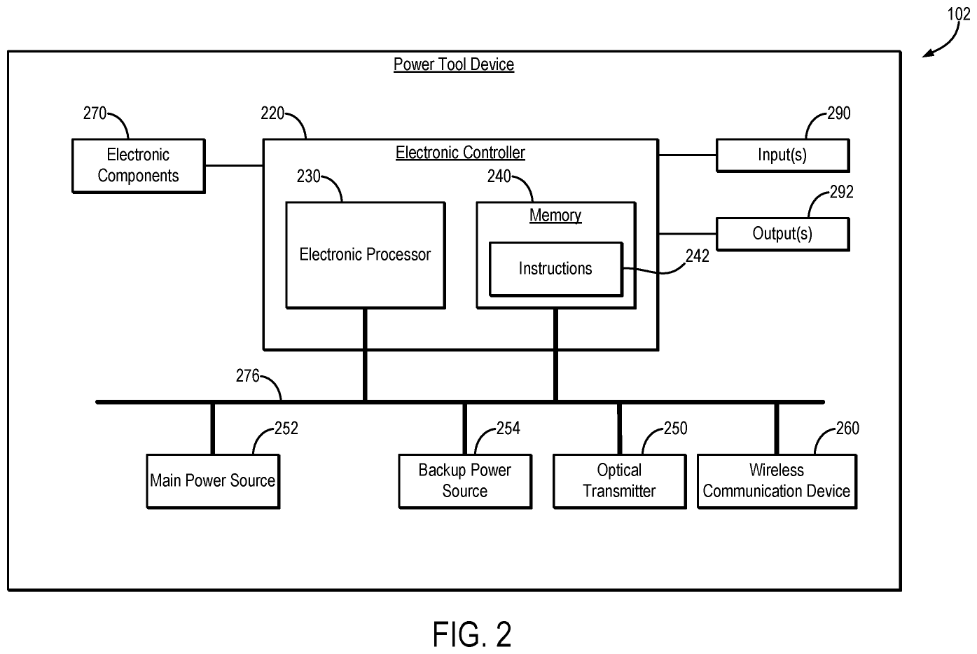

FIG. 2 shows a block diagram of an example power tool device 102, which may be one of the power tool devices 102a-102e shown in FIG. 1 or another suitable power tool device. The power tool device 102 includes an electronic controller 220, an optical transmitter 250, a main power source 252 (e.g., a battery pack, a portable power supply, and/or a wall outlet), etc. In the illustrated embodiment, the power tool device 102 also includes a backup power source 254 (e.g., a coil cell battery) and a wireless communication device 260. In other embodiments, the power tool device 102 may not include a backup power source 254. Similarly, in some embodiments, the power tool device 102 may not include a wireless communication device 260.

The electronic controller 220 can include an electronic processor 230 and memory 240. The electronic processor 230, the memory 240, and the optical transmitter 250 can communicate over one or more control buses, data buses, etc., which can include a device communication bus 276. The control and/or data buses are shown generally in FIG. 2 for illustrative purposes. The use of one or more control and/or data buses for the interconnection between and communication among the various modules, circuits, and components would be known to a person skilled in the art.

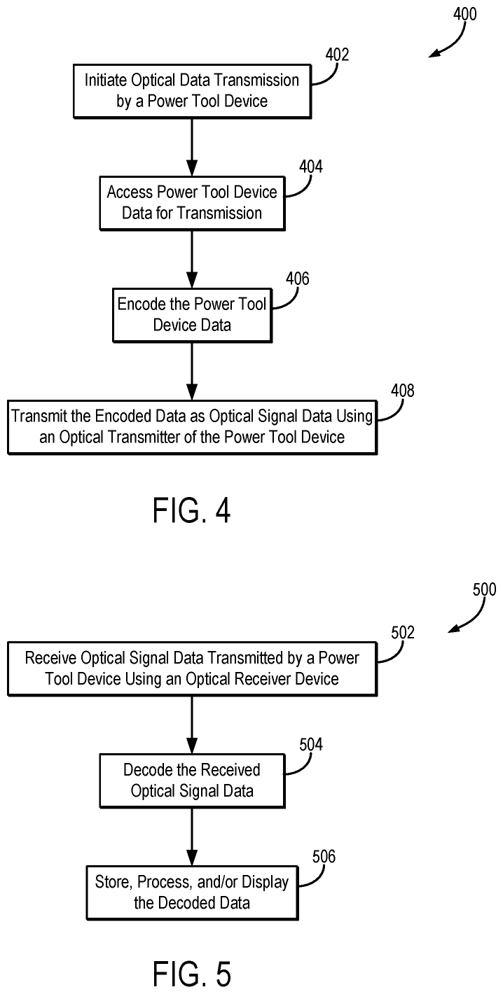

The electronic processor 230 can be configured to communicate with the memory 240 to store data and retrieve stored data. The electronic processor 230 can be configured to receive instructions 242 and data from the memory 240 and execute, among other things, the instructions 242. In particular, the electronic processor 230 executes instructions 242 stored in the memory 240. Thus, the electronic controller 220 coupled with the electronic processor 230 and the memory 240 can be configured to perform the methods described herein (e.g., the process 400 of FIG. 4 and/or the process 500 of FIG. 5 when the optical receiver device 104 is integral to a power tool device 102).

The memory 240 can include read-only memory (“ROM”), random access memory (“RAM”), other non-transitory computer-readable media, or a combination thereof. The memory 240 can include instructions 242 for the electronic processor 230 to execute. The instructions 242 can include software executable by the electronic processor 230 to enable the electronic controller 220 to, among other things, encode data (e.g., power tool device data), determine control parameters for the optical transmitter 250 based on the encoded data, and control operation of the optical transmitter 250 based on the determined control parameters. The software can include, for example, firmware, one or more applications, program data, filters, rules, one or more program modules, and other executable instructions.

The electronic processor 230 is configured to retrieve from memory 240 and execute, among other things, instructions related to the control processes and methods described herein. The electronic processor 230 is also configured to store data on the memory 240 including usage data (e.g., usage data of the power tool device 102 or another power tool device), maintenance data (e.g., maintenance data of the power tool device 102 or another power tool device), feedback data, power source data, sensor data (e.g., sensor data of the power tool device 102 or another power tool device), environmental data, operator data, location data, and the like.

Additionally, the electronic processor 230 can also be configured to store other data on the memory 240 including information identifying the type of power tool device, a unique identifier for the particular power tool device, user characteristics (e.g., identity, trade type, skill level), and other information relevant to operating or maintaining the power tool device 102 (e.g., received from an external source, such as the external device 104 or pre-programed at the time of manufacture). For example, other data that may be collected by, or otherwise stored on, the memory 240 can include tool name data (e.g., a custom tool name, a standard tool name, a tool model, a tool type), an owner name, key settings, key diagnostics, key analytics (e.g., number of users, whether the power tool device has been subject to heavy or light use), warranty information, error codes, security messages, unique tool identifiers (e.g., a serial number or ID), histograms or other statistics of a parameter (e.g., maximum currents, maximum temperatures, durations of use), sequential statistics of one or more tool runs (e.g., duration, power, and time of a tool run), classifications or regressions associated with one or more tool runs (e.g., classification of what application a tool was used for, regression of output torque, etc.), raw or processed data from one or more tool runs, an encrypted message containing any of the aforementioned data types, a qualitative representation of an aspect of a power tool (e.g., frequent or rare use), a warning (e.g., an indication that the tool has been dropped), a request for service, the time since last use, a state of charge (e.g., for battery packs), an indication that the power tool device is in need for repair, a verification that the power tool device has been updated to the same firmware (e.g., same blinking pattern), and/or a security key (e.g., which may be advantageous if combined with another encryption key transferred via a different means (e.g., Bluetooth® wireless protocol, Zigbee® wireless protocol)).

The memory 240 can also store data related to communications between the power tool device 102 and the optical receiver device 104. The electronic processor 230 controls optical communications between the power tool device 102 and the optical receiver device 104. For example, the electronic processor 230 buffers incoming and/or outgoing data, communicates with the electronic controller 220 of the power tool device 102, and determines the communication protocol and/or settings to use in optical communications.

As described above, the optical transmitter 250 is configured to generate optical signal data (e.g., light signals, an optically detectable image, optically detectable characters) that are detectable by an optical receiver device 104, thereby allowing for free-space optical communication between the power tool device 102 and the optical receiver device 104.

In some embodiments, the power tool device 102 may also include an optical receiver (e.g., an optical receiver device 104), or the optical transmitter 205 may be an optical transceiver and thus may be configured to receive information (e.g., configuration and programming information) from another power tool device 102 via the optical receiver or optical transceiver. When the power tool device 102 is also configured to receive data via an optical data transmission (e.g., using either a separate optical receiver, or an optical transmitter 205 that is configured as an optical transceiver), examples of data that can be received by the power tool device 102 include parameters (e.g., operational parameter for a power tool, charger operation parameters such as charging rate and charging targets for a power tool battery charger or battery pack), firmware updates, mode switches, unlocking codes, requests for information, internal logging (e.g., serial numbers), and the like. In some embodiments the power tool device 102 might both receive and transmit such signals such that more advance communication and encryption may be possible.

The optical transmitter 250 can be one or more LEDs or other lights of the power tool device 102 that have a primary function other than optical data transmission. For example, the optical transmitter 250 may be a work light of the power tool device 102, a status light of the power tool device 102, a mode light of the power tool device 102, a laser light of the power tool device 102, or other light of the power tool device 102. In these instances, the optical data transmission is the secondary function of the LED(s) or other light(s). In some embodiments, the optical transmitter 250 may be one or more dedicated LEDs or other lights of the power tool device 102, such that the primary function of the LED(s) or other light(s) is optical data transmission.

In some embodiments, the optical transmitter 250 can include one or more lights (e.g., LEDs) that are configured to generate light in a nonvisible spectrum, such as infrared (“IR”) light. In these instances, the optical receiver device 104 is configured to detect light in the same nonvisible spectrum (e.g., configured to detect IR light). For example, the optical transmitter 250 can include an IR LED and the optical receiver device 104 can include a photodiode, camera, or other photodetector that is configured to detect IR light.

In some embodiments, the optical transmitter 250 can be a flat panel display, such as a liquid crystal display (“LCD”) panel, an LED display panel, an electrophoretic display panel, and the like. The flat panel display can be configured to generate characters (e.g., a character display) or images. As an example, the flat panel display can be configured to generate images including bar codes, matrix bar codes (e.g., quick response (“QR”) codes), or other images that provide an encoded representation of data. As another example, the flat panel display can be configured to generate characters (e.g., single characters, character strings) that provide an encoded representation of data.

In some embodiments, the optical transmitter 250 can be within a separate housing along with the electronic controller 220 or another electronic controller, and that separate housing selectively attaches to the power tool device 102. For example, the separate housing may attach to an outside surface of the power tool device 102 or may be inserted into a receptacle of the power tool device 102. Accordingly, the optical communication (e.g., free-space optical communication) capabilities of the power tool device 102 can reside in part on a selectively attachable communication device, rather than integrated into the power tool device 102. Such selectively attachable communication devices can include electrical terminals that engage with reciprocal electrical terminals of the power tool device 102 to enable communication between the respective devices and enable the power tool device 102 to provide power to the selectively attachable communication device. In other embodiments, the optical transmitter 250 can be integrated into the power tool device 102, as described above.

In some embodiments, the main power source 252 can be an AC power source or a DC power source, which can be in electrical communication with one or more power outlets (e.g., AC or DC outlets). For instance, the main power source 252 can be an AC power source, for example, a conventional wall outlet, or the main power source 252 can be a DC power source, for example, a photovoltaic cell (e.g., a solar panel). Additionally or alternatively, the main power source 252 can be a battery pack (e.g., the power tool battery pack 102b of FIG. 1).

The power tool device 102 receives electrical power from the main power source 252 and optionally from a backup power source 254 based on which power supply is available. When the main power source 252 is connected to the power tool device 102 and the main power source 252 holds sufficient power, the main power source 252 provides electrical power to the power tool device 102, including the optical transmitter 250. If, on the other hand, the main power source 252 is not connected to the power tool device 102 (e.g., when a battery pack is not connected to a power tool, when a power tool battery charger is unplugged from a wall outlet) or when the main power source 252 otherwise does not hold sufficient power (e.g., when the battery cells of a battery pack are depleted), the backup power source 254 provides power to the optical transmitter 250. The backup power source 254, however, has limited supply of power and could be quickly drained if used to power significant electronic data exchange between the power tool device 102 and the optical receiver device 104. Therefore, in some embodiments, when the backup power source 254 powers the optical transmitter 250, the power tool device 102 outputs (e.g., broadcasts) only limited information (e.g., identification information) for the power tool device 102, but does not enable further data exchange between the power tool device 102 and the optical receiver device 104. In other embodiments, the backup power source 254 has sufficient power to enable full data exchange between the power tool device 102 and the optical receiver device 104.

In some embodiments, the backup power source 254 is a coin cell battery. The coin cell battery is removable from the power tool device 102 and is, therefore, located in an accessible area of the power tool device 102. In many embodiments, the backup power source 254 is accessed and replaced by the user/operator of the power tool device 102. In other embodiments, however, the backup power source 254 is located in a hard-to-access portion of the power tool device 102 and is replaced by a professional serviceperson. For instance, rather than being located in a dedicated battery recess accessible via a sliding or removable door on the power tool device housing, the backup power source 254 may require opening the main housing using one or more tools.

In some embodiments, the power tool device 102 may also include a wireless communication device 260. In these embodiments, the wireless communication device 260 is coupled to the electronic controller 220 (e.g., via the device communication bus 276). The wireless communication device 260 may include, for example, a radio transceiver and antenna, a memory, and an electronic processor. In some examples, the wireless communication device 260 can further include a GNSS receiver configured to receive signals from GNSS satellites, land-based transmitters, etc. The radio transceiver and antenna operate together to send and receive wireless messages to and from the external device 110, one or more additional power tool devices, the server 106, and/or the electronic processor of the wireless communication device 260. The memory of the wireless communication device 260 stores instructions to be implemented by the electronic processor and/or may store data related to communications between the power tool device 102 and the external device 110, one or more additional power tool devices, and/or the server 106.

The electronic processor for the wireless communication device 260 controls wireless communications between the power tool device 102 and the external device 110, one or more additional power tool devices, and/or the server 106. For example, the electronic processor of the wireless communication device 260 buffers incoming and/or outgoing data, communicates with the electronic processor 230 and determines the communication protocol and/or settings to use in wireless communications.

In some embodiments, the wireless communication device 260 is a Bluetooth® controller. The Bluetooth® controller communicates with the external device 110, one or more additional power tool devices, and/or the server 106 employing the Bluetooth® protocol. In such embodiments, therefore, the external device 110, one or more additional power tool devices, and/or the server 106 and the power tool device 102 are within a communication range (i.e., in proximity) of each other while they exchange data. In other embodiments, the wireless communication device 260 communicates using other protocols (e.g., Wi-Fi® wireless protocol, Zigbee® wireless protocol, cellular protocols, a proprietary protocol, etc.) over a different type of wireless network. For example, the wireless communication device 260 may be configured to communicate via Wi-FiR through a wide area network such as the Internet or a local area network, or to communicate through a piconet (e.g., using infrared or NFC communications). The communication via the wireless communication device 260 may be encrypted to protect the data exchanged between the power tool device 102 and the external device 110, one or more additional power tool devices, and/or the server 106 from third parties.

The wireless communication device 260, in some embodiments, exports usage data, other power tool device data, and/or other data as described above from the power tool device 102 (e.g., from the electronic processor 230).

In some embodiments, the wireless communication device 260 can be within a separate housing along with the electronic controller 220 or another electronic controller, and that separate housing selectively attaches to the power tool device 102. For example, the separate housing may attach to an outside surface of the power tool device 102 or may be inserted into a receptacle of the power tool device 102. Accordingly, the wireless communication capabilities of the power tool device 102 can reside in part on a selectively attachable communication device, rather than integrated into the power tool device 102. Such selectively attachable communication devices can include electrical terminals that engage with reciprocal electrical terminals of the power tool device 102 to enable communication between the respective devices and enable the power tool device 102 to provide power to the selectively attachable communication device. In other embodiments, the wireless communication device 260 can be integrated into the power tool device 102.

In some embodiments, the power tool device 102 also optionally includes additional electronic components 270. The electronic components 270 can include, for example, one or more of an audio element (e.g., a speaker), a radio frequency identification (“RFID”) tag to store a power tool device identification number, and/or an RFID reader to read the power tool device identification number stored on an RFID tag of another power tool device (e.g., the power tool device 102 may be a power tool and the other power tool device may be a battery pack). The electronic components 270 may further include one or more switches (e.g., for initiating and ceasing operation of the power tool device), one or more sensors, one or more motors, etc. For example, in a motorized power tool (e.g., drill-driver, saw, etc.), electronic components 270 can include, for example, an inverter bridge, a motor (e.g., brushed or brushless) for driving a tool implement, etc. For a non-motorized power tool (e.g., a work light, a work radio, ruggedized tracking device, etc.), the electronic components 270 can include, for example, one or more of a lighting element (e.g., LEDs for illuminating a work area), an audio element (e.g., a speaker), a power source, etc. In some embodiments, electronic controller 220 can be configured to control one or more of electronic components 270. For example, in instances where the power tool device 102 is a motorized power tool and the electronic components 270 include a motor and a sensor for sensing actuation of a trigger of a power tool, the electronic controller 220 can be configured to control an inverter bridge or otherwise control driving of the motor based on sensed actuation of the trigger.

In some embodiments, the power tool battery device 102 can include one or more inputs 290 (e.g., one or more buttons, switches, and the like) that are coupled to the electronic controller 220 and allow a user to select a mode of the power tool device 102, or the like. In some embodiments, the input 290 includes a single actuator (e.g., a button or a switch) that can initiate the optical transmitter 250 to begin transmitting data.

In some embodiments, the power tool device 102 may include one or more outputs 292 that are also coupled to the electronic controller 220. The output(s) 292 can receive control signals from the electronic controller 220 to generate a visual signal to convey information regarding the operation or state of the power tool device 102 to the user. The output(s) 292 may include, for example, LEDs or a display screen and may generate various signals indicative of, for example, an operational state or mode of the power tool device 102, an abnormal condition or event detected during the operation of the power tool device 102, and the like. For example, the output(s) 292 may indicate the state or status of the power tool device 102, an operating mode of the power tool device 102, and the like.

In those instances where the output(s) 292 include LEDs, other lights, and/or flat panel displays, the output(s) 292 may have a primary function that is different from optical data transmission, and the optical transmitter 250 may be separate and distinct from the output(s) 292. Alternatively, some or all of the output(s) 292 may also be operable with a secondary function to generate optical signal data in addition to, or in lieu of, the optical transmitter 250.

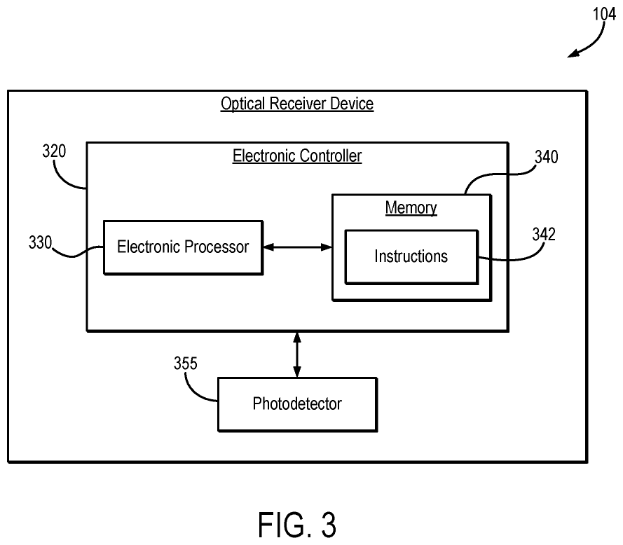

FIG. 3 illustrates an example optical receiver device 104, which may be a standalone optical receiver device 104, or may be integrated into another device, such as a power tool device 102 or external device 110. The optical receiver device 104 generally includes an electronic controller 320 having an electronic processor 330 and a memory 340. The optical receiver device 104 also include a photodetector 355, which may be a light sensor; a photodiode; an active-pixel sensor (“APS”), which may be an APS in a camera; a charge-coupled device (“CCD”), which may be a CCD in a camera; or other suitable photodetector.

The electronic processor 330 can be configured to communicate with the memory 340 to store data and retrieve stored data. The electronic processor 330 can be configured to receive instructions 342 and data from the memory 340 and execute, among other things, the instructions 342. In particular, the electronic processor 230 executes instructions 342 stored in the memory 340. Thus, the electronic controller 320 coupled with the electronic processor 330 and the memory 340 can be configured to perform the methods described herein (e.g., the process 500 of FIG. 5).

The memory 240 can include ROM, RAM, other non-transitory computer-readable media, or a combination thereof. The memory 340 can include instructions 342 for the electronic processor 330 to execute. The instructions 342 can include software executable by the electronic processor 330 to enable the electronic controller 320 to, among other things, decode data (e.g., optical signal data). The software can include, for example, firmware, one or more applications, program data, filters, rules, one or more program modules, and other executable instructions.

The electronic processor 330 is configured to retrieve from memory 340 and execute, among other things, instructions 342 related to the control processes and methods described herein. The electronic processor 330 is also configured to store data on the memory 340 including decoded optical signal data, and the like.

In some embodiments, the optical receiver device 104 can be a standalone camera (i.e., the primary function of the optical receiver device 104 is to capture images and/or videos) or a device that has a camera (i.e., the primary function of the optical receiver device 104 may be different from capturing images and/or videos, such as for a smartphone that has a camera). The camera may be a standalone camera (e.g., a security camera, a webcam), or may be integrated in another device. For example, the camera may be a smartphone camera. In some instances, the optical receiver device 104 can include a camera that is integrated, or otherwise coupled to, the external device 110. The photodetector 355 of the camera can be configured to detect light in the visible spectrum and/or a nonvisible spectrum (e.g., an infrared spectrum).

The optical receiver device 104 may be also be implemented as, or coupled to, a device with a second function. For example, as noted above the optical receiver device 104 may be a security camera. Using a security camera to implement the optical receiver device 104 has the advantage of the security camera being always, or regularly, on. In some applications, the security camera may be located in a tool crib or other locations where there may be multiple power tool devices 102 (e.g., a store, a warehouse, an assembly line, during shipping or transport of power tool devices 102). In these instances, the optical receiver device 104 can provide an automatic inventory of power tool devices 102 that appear present. Automatic alerts may be generated by the electronic processor 330 of the optical receiver device 104 (e.g., via text messages or other messages sent from the optical receiver device 104 to the external device 110) for power tool devices 102 that appear to be missing from the inventory. A security camera is also usually connected to a greater network system (e.g., via network 108). By having one or more security cameras in a tool crib or other location where power tool devices 102 are located, a set of power tool devices 102 may transmit messages periodically in a way such that the security camera(s) may receive messages from all such devices.

A power tool device storage system may be designed such that the optical transmitter 250 of the respective power tool devices 102 may be visible to the optical receiver device 104. For example, a power tool device storage system may include a clear hard or soft case for power tool devices 102 that provides an orientation of the power tool devices 102 to have their respective optical transmitter 250 visible to the optical receiver device 104. In some embodiments, the power tool device storage system may be implemented with power tool battery chargers that are designed such that the LEDs for the attached battery packs are oriented in a common direction. Additionally or alternatively, the power tool device storage system may also implement light pipes, fiber optics, or other optics such that the light information generated by the optical transmitters 250 of the respective power tool devices 102 are transmitted to a second or further direction or distance.

A camera system incorporating the optical receiver device 104 may also be employed to not just receive the optical signal data from the optical transmitters 250 of the respective power tool devices 102, but also to track the relative location (e.g., in pixels; GPS coordinates; proximity to other power tool devices; jobsite; if a location has moved, and if so how much or how fast the location has been moved) via this process.

In some embodiments, the optical receiver device 104 can be implemented in a standalone reader that can read, detect, or otherwise receive optical signal data sent from a power tool device 102. For example, the optical receiver device 104 may be a handheld diagnostic reader (e.g., a battery powered diagnostic reader) used for service. In these instances, the optical receiver device 104 can include a display or user interface that can provide a user with more detailed warranty or repair information based on power tool device data received from the power tool device 102 via optical data transmission.

As another example, the optical receiver device 104 may be a part of a power tool device 102. For example, the optical receiver device 104 may be implemented as a light sensor or other photodetector on a power tool device 102, such as a power tool battery charger. As another example, the optical receiver device 104 can be implemented on a power tool device 102 that is a work light (e.g., power tool device 102e) that may be placed on a jobsites and, advantageously, in good visibility to see many other power tool devices 102. The work light may additionally include wireless communication capabilities, such that the work light can communicate with the external device 110 and/or server 106 (e.g., via the network 108 or directly). In a related embodiment, the optical receiver device 104 can be configured to be placed within a job box where the surrounding lights may be low. This has the advantage that a simple ambient light sensor can be sensitive enough to detect light signals emitted by the optical transmitters 205 of power tool devices 102 placed within the job box.

In some embodiments, the optical receiver device 104 can also be implemented as a light sensor or other photodetector on a peripheral device other than a power tool device 102. For example, the optical receiver device 104 can be implemented as a light sensor or other photodetector coupled to a power outlet and/or surge protector, or an edge device (e.g., such as a Wi-Fi® hub, a Wi-Fi® repeater, a cell phone repeater, a Bluetooth® repeater, a “sentinel” device, etc.) that is otherwise operable to transmit data through other means of wireless communication.

FIG. 4 illustrates a process 400 of transmitting data from a power tool device (e.g., power tool device 102) using optical communication, such as free-space optical communication.

Optical data transmission from the power tool device 102 is first activated or otherwise initiated, as indicated at step 402. The activation of optical data transmission can be initiated by a user (e.g., via an input 290 of the power tool device 102, via a graphical user interface on an external device 110). For example, optical data transmission can be activated by a user activating an input 290 (e.g., a trigger, button, or other user interface action) having a specialized function to initiate optical data transmission. As another example, a battery pack could activate optical data transmission from a long press of a battery state-of-charge button. A power tool or other power tool device 102 could also initiate optical data transmission by being shook by a user, by repeated pulses of a trigger, by cycling a mode switch, by repeated rotation of a clutch ring, by a series of user interface actions, a sustained button press, or the like.

In other embodiments, optical data transmission can be activated or otherwise initiated according to a schedule (e.g., as determined or based on a clock of the power tool device 102). For example, optical data transmission may be activated at a random periodicity or at fixed intervals. In some implementations, internal clocks of the power tool devices 102 may be sufficiently out-of-synchronization so as to prevent or reduce the likelihood that messages transmitted from different power tool devices 102 interfere with each other. The optical data transmission can also be initiated based on time and date information. For example, optical data transmission can be scheduled to occur during certain hours of the day (e.g., at night). Optical data transmission may also be initiated based on a duration of time since a power tool device 102 has last been used. For example, a work light might otherwise turn off (e.g., after 10 seconds of the work light being turned on), so the work light may initiate optical data transmission before automatically turning itself off.

Additionally or alternatively, optical data transmission can be activated based on one or more conditions. For example, optical data transmission may be initiated by a battery pack when the battery pack reaches a full charge or a target charge level. Similarly, optical data transmission from a battery pack and/or a power tool battery charger may be initiated when the battery pack is placed on the power tool battery charger, or optical data transmission from a battery pack and/or a power tool may be initiated when the battery pack is placed on the power tool. As another example, a power tool or power tool battery charger could activate optical data transmission in response to detecting rapid attachment or removal of a battery pack.

A power tool device 102 may also initiate optical data transmission when a particular action takes place, or when a particular operating condition is met or detected. For example, a power tool may initiate optical data transmission when the power tool exhibits a fault, stall, or a sensor is detected as faulty (i.e., so the power tool automatically sends an error code and any relevant data via optical data transmission). A power tool may also initiate optical data transmission after one or more unloaded runs of the power tool.

In step 404, when optical data transmission is initiated, the power tool device 102 accesses or otherwise retrieves the relevant data to be transmitted from its memory 240. For example, the electronic processor 230 can retrieve power tool device data or other data stored in the memory 240 of the electronic controller 220. In some embodiments, the power tool device 102 can receive data from another connected power tool device. As an example, when the power tool device 102 is a battery pack that is connected to a power tool or a power tool battery charger, the electronic process 230 of the battery pack may also access data (e.g., power tool device data) from the connected power tool or power tool battery charger. For instance, a power tool can send an error code to the electronic processor 230 to be displayed on the battery pack. In these instances, the battery pack can optically transmit data from the connected power tool or power tool battery charger to the optical receiver device 104. This can be useful, for example, when a power tool may not otherwise have an LED or other optical transmitter 250 that is operable to generate optical signal data.

The electronic processor 230 then encodes the data (e.g., power tool device data) retrieved or otherwise accessed from the memory 240 of the power tool device 102, as indicated at step 406. The encoded data include control parameters for controlling the optical transmitter 250 to generate optical signal data (e.g., light signals, images, characters) that indicate an encoded representation of the data retrieved or otherwise accessed from the memory 240 of the power tool device 102. As described below, the encoded data can be generated using various different encoding schemes. For example, the encoded data can be generated using a binary encoding (e.g., by switching an LED between an “on” state and an “off” state”) or using non-binary encoding schemes (e.g., by varying one or more characteristics of light generated by an LED, such as amplitude, frequency, wavelength, and/or color). In some implementations, the encoded data can be generated using a line code, which may include using unipolar encoding, polar encoding, bipolar encoding, or the like. For example, the encoded data can be generated using a line code such as a return-to-zero (“RZ”) line code, a non-return-to-zero (“NRZ”) line code (e.g., an NRZ-level, NRZ-inverted, and/or NRZ-space line code), a Manchester code, a differential Manchester code, an optical line code, or the like. It will be appreciated that types of data encoding schemes other than those expressly described can also be utilized.

The electronic processor 230 can also determine control parameters for modulating light generated by the optical transmitter 250 (e.g., light generated by one or more LEDs of the power tool device 102) so as to implement encoding schemes other than a binary encoding. For example, the control parameters can include control parameters for modulating one or more characteristics of light generated by the optical transmitter 250 (e.g., an amplitude or intensity, a frequency, a wavelength, a color). Similarly, when the optical transmitter 250 includes a flat panel display, the encoded data can be generated using an encoding scheme that generates an encoded representation of the data as an image (e.g., a barcode, a QR code or other matrix barcode), a character, or a series of characters.

For example, in some embodiments modulating the light generated by the optical transmitter 250 can include turning an LED on and off to encode data as binary optical signal data. Alternatively, the LED can be turned on and off to encode data using other data encoding schemes by adjusting the duration of time that the LED is in the “on” state, such as using morse code or the like.

In some other embodiments, modulating the light generated by the optical transmitter 250 can include adjusting the brightness of an LED in order to encode data as analog and/or digital optical signal data other than a binary encoding. The light emission may vary in intensity such that minimal battery use is employed but data are sent more frequently.

Additionally or alternatively, modulating the light generated by the optical transmitter 250 can include adjusting a color of light being generated by the optical transmitter 250 in order to encode data. In some embodiments, the light generated by the optical transmitter 250 can be emitted at a particular wavelength. Individual power tool devices 102 (e.g., individual power tools, individual power tool battery chargers, individual battery packs) may be identified by the particular wavelength(s) of light being emitted. For example, a first power tool 102c may have an optical transmitter 250 configured to generate light at a first wavelength and a second power tool 102d may have an optical transmitter 250 configured to generate light at a second wavelength that is different from the first wavelength. In this example, the optical receiver device 104 can be configured to differentiate optical signal data received from the first power tool 102c from optical signal data received from the second power tool 102d based on the first and second wavelengths.

Additionally or alternatively, individual types of power tool devices 102 may be identified by the particular wavelength of light being emitted. For example, the optical transmitter 250 of impact drivers may emit light at one wavelength, whereas the optical transmitter 250 of reciprocating saws may emit light at another wavelength; or, the optical transmitter 250 of battery packs having a nominal voltage of 12 V may emit light at one wavelength, whereas the optical transmitter 250 of battery packs having a nominal voltage of 18 V may emit light at another wavelength; or, the optical transmitter 250 of power tools may emit light at a first wavelength, whereas the optical transmitter 250 of battery packs emit light a second wavelength and the optical transmitter 250 of power tool battery chargers emit light at a third wavelength; or, combinations thereof. In this way, the optical receiver device 104 can be configured to differentiate optical signal data received from different types of power tool devices 102.

In some embodiments, different ranges of wavelengths of light can be generated for different power tool devices 102 or different types of power tool devices 102. For example, a range of wavelengths of light may be assigned based on power tool device data (e.g., operator data, location data). Additionally or alternatively, different ranges of wavelengths of light may be assigned to different types of power tool devices 102. For example, a first range of wavelengths (e.g., 500-565 nm) may be assigned to a first type of power tool device 102 and a second range of wavelengths (e.g., 565-590 nm) may be assigned to a second type of power tool device 102. The different types of power tool devices 102 may include different types of power tools, battery packs with different nominal voltages, power tools versus battery packs or power tool battery chargers, and so on.

The optical transmitter 250 can also be configured to change the wavelength, frequency, or color of light being emitted in order to improve contrast, and therefore detection of the emitted light by the optical receiver device 104. In some embodiments, the wavelength, frequency, or color of the light emitted by the optical transmitter 250 can be adjusted by a user (e.g., via the external device 110 or via an input or other control on the power tool device 102). In some other embodiments, the wavelength, frequency, or color of light emitted by the optical transmitter 250 can be automatically adjusted by the power tool device 102 or another connected device such as the external device 110, the server 106, another power tool device, a wireless communication device (e.g., a gateway device, a control hub, an access point, or other device in a wireless communication network), or the like. For example, the power tool device 102 or other connected device may know or learn (e.g., via a machine learning controller of the power tool device 102 or other connected device) that a particular wavelength, frequency, or color of light may improve detection of the light emitted by the optical transmitter 250. When this optimized wavelength, frequency, or color of light is determined by a connected device other than the power tool device, the connected device can communicate the optimized wavelength, frequency, or color of light to the power tool device 102 (e.g., via a wireless or wired connection).

When the optical transmitter 250 includes more than one light (e.g., more than one LED), modulating the light generated by the optical transmitter 250 can include synchronizing the lights such that they generate light in the same pattern at the same time. This can be advantageous for increasing the optical detection efficiency of the optical receiver device 104 by making the light generated by the optical transmitter 250 easier to detect. In other embodiments, the multiple lights (e.g., multiple LEDs) can be independently modulated to increase the data transmission rate. For example, individual LEDs can be modulated together to send signals in parallel (e.g., eight LEDs could send one byte at a time, four LEDs can send a half byte at a time). Additionally or alternatively, individual LEDs can be modulated independently of each other to transmit multiple data streams at a time, or sequentially.

When the optical transmitter 250 includes a flat panel display configured to generate an image, the control parameters can define an image to be displayed on the flat panel display. The image can include a bar code, a matrix bar code (e.g., a QR code), or another image that provides an encoded representation of the data. In other embodiments, the flat panel display may be configured to generate one or more characters (e.g., a character display). In these instances, the control parameters can define one or more characters to be displayed by the flat panel display. A display of characters can be mapped to a computational representation (e.g., hex data) or be read directly as text (e.g., using optical character recognition).

The encoded data may also be encrypted. Decryption may require a user (or device) to know the ID or aspect of the sending device in order to decrypt the message.

The encoded data may also be encoded in a human readable manner, such as using morse code. Encoding the data according to a morse code can be advantageous for short messages. One advantage of using morse code (or other standard blinking data transfer protocols) is that the optical receiver device 104 may be implemented on a smartphone or the like with an app that is configured to decode the morse code. Other standard blinking transfer protocols may include a series of flashes or blinks that may be decoded by a user based on a list of such codes (e.g., codes indicating an error or need for service).

The electronic controller 220 controls the optical transmitter 250 to transmit the encoded data as optical signal data, as indicated at step 408. In some embodiments, the optical transmitter 250 can transmit the optical signal data as light signals generated by one or more LEDs or other lights. In some other embodiments, the optical transmitter 250 can transmit the optical signal data by displaying an image, a character, or multiple characters on a flat panel display.

When the optical signal data include light signals generated by one or more LEDs or other lights, the optical signal data can be transmitted using various different modulation schemes. For example, analog signals can be modulated using amplitude modulation, frequency modulation, phase modulation, or the like. Similarly, digital signals can be modulated using an amplitude shift keying (“ASK”) modulation, a frequency shift keying (“FSK”) modulation, or other suitable digital modulation scheme. ASK modulation may be implemented using pulse position encoding, pulse distance encoding, pulse width encoding, Manchester encoding, or the like. FSK modulation may be implemented using binary FSK, continuous-phase FSK, Gaussian FSK, minimum-shift keying, or the like.

In some embodiments, the optical transmitter 250 can be one or more lights of the power tool device 102. For example, the optical transmitter 250 can be one or more light emitting diodes (“LEDs”) of the power tool device 102. When the optical transmitter 250 uses multiple LEDs or other lights to transmit multiple data streams, the optical signal data can be modulated and/or multiplexed using various techniques, such as hierarchical modulation or layered modulation, time-division multiplexing, frequency-division multiplexing, and the like.

As described above, in some instances, the encoded data are encrypted before being transmitted by the optical transmitter 250 as optical signal data. In these instances, a security key is used to decrypt the encrypted data. This security key data can be transmitted as optical signal data by the optical transmitter 250, or may be transmitted by the power tool device 102 using other means of communication (an out-of-band communication). For example, security key data for decrypting encoded data that have been encrypted can be transmitted from a wireless communication device 260 of a power tool device 102 (e.g., via a Bluetooth®, Zigbee®, Wi-Fi®, NFC connection). The security key data can be transmitted to the optical receiver device 104, which may then be passed on to the external device 110 or server 106, or the security key data may be transmitted directly to the external device 110 or server 106.

In some embodiments, the optical signal data may be transmitted multiple times (i.e., the transmitted data packet may be repeated multiple times). For example, the same optical signal data packet, or packets, can be transmitted for a certain number of repetitions, at regular intervals over a fixed period of time, until optical data transmission is terminated by a user (e.g., by actuating a switch that ceases optical data transmission), or the like. The repeated transmission of optical signal data may be useful, for example, when the optical signal data are providing an encoded representation of an error code or other diagnostic that is pertinent to the safe and/or correct operation of the power tool device 102.

In some embodiments, the baud rate (“Bd”) of the transmitted optical signal data may be determined or otherwise selected by the electronic processor 230 and sent at a rate that can be picked up from a standard camera (e.g., 30 frames per second, 60 frames per second, etc.). For example, with a baud rate of 30 frames per second, a particular light may be controlled to indicate and transition between 30 distinct information elements or symbols per second. Alternatively, the electronic processor 230 can set the baud rate at a rate higher than 30-60 Bd when the optical receiver device 104 can detect signals at that higher baud rate. Accordingly, in some embodiments, the baud rate of the transmitted optical signal data results in symbol transitions at a rate greater than a rate generally perceivable by a human (e.g., above about 60 Bd). In some embodiments, the baud rate of the transmitted optical signal data results in symbol transitions that are generally perceptible by a human (e.g., between 10-60 Bd, 24-60 Bd, 24-40 Bd, or another range), but not generally comprehendible by a human. That is, a human may be able to perceive a light modulated 24 times a second, but not reasonably decode a message encoded by a light modulated at that rate (e.g., where each modulation represents a bit of information).

When more than one messages (e.g., packets of optical signal data) are being transmitted, the electronic processor 230 may control the optical transmitter 250 to pause between messages (e.g., data packets) being sent in order to improve the detection efficiency or otherwise reduce the detection error rate of the optical receiver device 104.

In some embodiments, the optical signal data can be preceded by a particular pattern (e.g., a pattern of light signals). For example, the optical signal data can be preceded by a pattern of blinking or flashing an LED a certain number of times (e.g., five times). This preceding optical transmission can be detected by the optical receiver device 104 to initiate detection of the optical signal data and/or to help calibrate the reading algorithm for threshold, baud rate, and clock speed.

The optical signal data transmitted by the optical transmitter 250 may also include a checksum, parity check, or other verification data, which may be added to the optical signal data by the electronic processor 230 before the optical signal data are transmitted by the optical transmitter 250.

When the optical transmitter 250 is configured to transmit optical signal data as infrared light signals, the optical signal data may be transmitted using a standard protocol, such as the Infrared Data Association (“IrDA”) protocol.

Additionally or alternatively, the optical signal data generated by the optical transmitter 250 may be modulated in a way that indicates a relative use of the power tool device 102 relative to other power tool devices 102. For example, tool crib owners may want to know the frequency that a particular power tool is being used relative to others in an inventory. In these instances, a brightness, pulse-width modulation (“PWM”), smooth wave frequency, etc., of light generated by an LED may be associated with the relative tool use (e.g., by varying the characteristics of the light being generated by the LEDs based on the relative use frequency of the power tool or other power tool device).

FIG. 5 is a flowchart illustrating a process 500 of receiving, by an optical receiver device 104, optical signal data that have been transmitted by an optical transmitter 250 of a power tool device 102 (e.g., according to process 400) and decoding, storing, and/or otherwise processing the received data.

The optical signal data transmitted by the optical transmitter 250 (e.g., according to process 400) are received by the optical receiver device 104, as indicated at step 502. For example, the optical receiver device 104 can detect light signals generated by one or more LEDs or other lights, or can read an image, character, or characters displayed on a flat panel display.

The received optical signal data are then decoded by the electronic processor 330 of the optical receiver device 104, as indicated at step 504. For example, a suitable decoding technique can be used to decode the optical signal data that were encoded according to a particular encoding scheme by the electronic processor 230 of the power tool device 102.

In some other embodiments, the received optical signal data are not decoded by the electronic processor 330 of the optical receiver device 104 and instead the encoded data are stored in the memory 340 of the optical receiver device 104 or are transmitted on to another device, such as the external device 110 or the server 106 via a wired or wireless connection.

The decoded data are then stored in a memory 340 of the optical receiver device 104, as indicated at step 506. Additionally or alternatively, the decoded data can be processed by the electronic processor 330 of the optical receiver device 104 in order to generate a display to a user (e.g., an alert corresponding to an error message received from the power tool device 102 in the optical signal data). It still other instances, the decoded data can be transmitted by the optical receiver device 104 to an external device 110 and/or server 106. For example, the decoded data can be transmitted to the external device 110 and/or server 106 via a wireless connection (either directly, or indirectly via the network 108) or a wired connection. As a non-limiting example, the decoded data can indicate a serial number of the power tool device, and the decoded data can be transmitted from the optical receiver device 104 to the external device 110 (e.g., a smartphone) where the serial number of the power tool device can be displayed to a user.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates, etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (e.g., hard disks, floppy disks), optical media (e.g., compact discs, digital video discs, Blu-ray discs), semiconductor media (e.g., random access memory (“RAM”), flash memory, electrically programmable read only memory (“EPROM”), electrically erasable programmable read only memory (“EEPROM”)), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (“CD”), digital versatile disk (“DVD”), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (“LAN”). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and both items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The provided detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A method for optically transmitting data from a power tool device, the method comprising:
transmitting data stored in a memory of the power tool device as optical signal data by modulating light generated by a light emitting diode of the power tool device, wherein the light emitting diode has a primary function that is different from optical data transmission;
receiving, by an optical receiver device, the optical signal data by detecting the light generated by the optical transmitter of the power tool device; and
storing the received optical signal data in a memory of the optical receiver device.

2. The method of claim 1, wherein the power tool device comprises a power tool battery charger, a power tool battery pack, a power tool, or a work light.

3. The method of claim 1, wherein the power tool device comprises a power tool battery charger and the primary function of the light emitting diode comprises indicating a charging status for the power tool battery charger.

4. (canceled)

5. The method of claim 1, wherein the power tool device comprises a power tool battery pack and the primary function of the light emitting diode comprises indicating a state-of-charge of the battery pack.

6. (canceled)

7. The method of claim 1, wherein the power tool device comprises a power tool and the primary function of the light emitting diode comprises indicating a mode of operation of the power tool.

8. (canceled)

9. The method of claim 1, wherein the power tool device comprises a work light and the primary function of the light emitting diode comprises illuminating a space.

10. The method of claim 1, wherein transmitting the data stored in the memory of the power tool device as optical signal data comprises:
accessing the data from the memory of the power tool device;
encoding the data using an electronic processor of the power tool device, generating encoded data that include control parameters for modulating the light generated by the light emitting diode; and
transmitting the optical signal data using the electronic processor to modulate the light generated by the light emitting diode based on the control parameters in the encoded data.

11. The method of claim 10, wherein encoding the data using the electronic processor comprises encoding the data using at least one selected from a group of a binary encoding or a line code.

12. (canceled)

13. (canceled)

14. The method of claim 10, wherein the control parameters indicate at least one selected from a group of an analog modulation of the light generated by the light emitting diode, a digital modulation of the light generated by the light emitting diode, modulating an amplitude of the light generated by the light emitting diode, modulating a color of the light generated by the light emitting diode.

15. (canceled)

16. (canceled)

17. (canceled)

18. The method of claim 1, wherein the optical receiver device comprises at least one selected from a group of a camera or a photodetector.

19. The method of claim 1, wherein the optical receiver device comprises a camera, and wherein the camera is coupled to at least one selected from a group of a mobile device or a standalone security camera.

20. (canceled)

21. (canceled)

22. The method of claim 1, wherein the optical receiver device comprises a photodetector, and wherein the photodetector is coupled to a second power tool device.

23. A power tool device comprising:
a housing;
an optical transmitter coupled to the housing and configured to transmit optical signal data as light signals in a visible spectrum;
a memory configured to store power tool device data;
an electronic processor coupled to the optical transmitter and the memory, the electronic processor being configured to:
retrieve the data from the memory;
encode the data as optical signal data for transmission by the optical transmitter; and
control the optical transmitter to transmit the optical signal data.

24. The power tool device of claim 23, wherein the optical transmitter comprises a light emitting diode and the electronic processor is configured to:
encode the data as the optical signal data by determining control parameters for modulating light generated by the light emitting diode; and
control the light emitting diode to transmit the optical signal data by modulating light generated by the light emitting diode based on the control parameters.

25. A power tool device comprising:
a housing;
a flat panel display coupled to the housing and configured to transmit optical signal data;
a memory configured to store power tool device data;
an electronic processor coupled to the flat panel display and the memory, the electronic processor being configured to:
retrieve the data from the memory;
encode the data as optical signal data indicating an encoded representation of the data retrieved from the memory; and
control the flat panel display to generate the optical signal data as a display element on the flat panel display.

26. The power tool device of claim 25, wherein the flat panel display comprises at least one selected from a group of a liquid crystal display, a light emitting diode display, or an electrophoretic display.

27. (canceled)

28. (canceled)

29. The power tool device of claim 25, wherein the electronic processor is configured to generate the display element as an image.

30. The power tool device of claim 29, wherein the electronic processor is configured to encode the data as optical signal data indicating the encoded representation of the data as a quick response (QR) code.

31. The power tool device of claim 23, wherein the power tool device comprises at least one selected from a group of a power tool, a power tool battery pack, a power tool battery charger, or a work light.

32. The power tool device of claim 25, wherein the power tool device comprises at least one selected from a group of a power tool, a power tool battery pack, a power tool battery charger, or a work light.

33. (canceled)
